(19) United States
(12) Patent Application Publication
(10) Pub. No.: US 2026/0187238 A1
(43) Pub. Date: Jul. 2, 2026

(54) ANOMALY CAUSE DETECTION METHOD, APPARATUS, ELECTRONIC DEVICE AND STORAGE MEDIUM

(71) Applicant: SKSPRUCE TECHNOLOGIES CO., LTD., Chengdu (CN)

(72) Inventors: Yongcheng LEI, Chengdu (CN); Yee SOON, Chengdu (CN); Fang WU, Chengdu (CN); Siyuan WANG, Chengdu (CN)

(21) Appl. No.: 19/424,260

(22) Filed: Dec. 18, 2025

(30) Foreign Application Priority Data
Dec. 29, 2024 (CN) 202411956852.8

(51) Int. Cl. G06F 21/55

(52) U.S. Cl. CPC G06F 21/554; G06F 21/552

(57) ABSTRACT

An anomalous cause detection method, apparatus, electronic device and storage medium are provided, relate to the field of artificial intelligence. Multiple types of anomaly detection operations are performed on logs generated by a target system to obtain anomaly scores for respective detection types. Anomaly score time-series curves corresponding to the detection types are generated. Correlation analysis is performed on the anomaly score time-series curves. Correlated anomaly score time-series curves are fused into a comprehensive anomaly score time-series curve. A detection type corresponding to the comprehensive anomaly score time-series curve is determined. Anomaly detection is performed on the comprehensive anomaly score time-series curve, and an anomaly time instant is determined. An anomaly log is searched for based on the anomaly time instant and the detection type corresponding to the comprehensive anomaly score time-series curve, thereby determining an anomaly cause of the target system based on the anomaly log.

### CROSS REFERENCE TO RELATED APPLICATION

The present invention claims priority under 35 U.S.C. § 119 to Chinese Patent Application No.202411956852.8, titled “ANOMALY CAUSE DETECTION METHOD, APPARATUS, ELECTRONIC DEVICE AND STORAGE MEDIUM” filed on Dec. 29, 2024 with the China National Intellectual Property Administration (CNIPA), the entire contents of which being incorporated herein by reference.

### FIELD

The present disclosure relates to the field of artificial intelligence, and particularly to an anomaly cause detection method, an anomaly cause detection apparatus, an electronic device and a storage medium.

### BACKGROUND

In modern large-scale computing environment, the vast amount of logs generated by systems provides basic data for fault detection and system monitoring. However, conventional rule-based log analysis methods mostly adopt single-dimensional rule detection approaches, which only have limited detection capabilities and struggle to handle multi-dimensional anomaly correlations in complex systems.

In addition, related technologies are inefficient in locating the root causes of anomalies, especially with limited capability to filter effective information from large volumes of log data, and thus failing to assist users in analyzing the specific causes of system anomalies.

### SUMMARY

The objective of the present disclosure is to provide an anomaly cause detection method, an anomaly cause detection apparatus, an electronic device and a storage medium. Anomaly score time-series curves may be generated through multiple detection operations, which are different from each other, on a log line in a target system, correlated anomaly score time-series curves are fused into a comprehensive anomaly score time-series curve based on the set correlation, an anomaly time may be located in the comprehensive anomaly score time-series curve in the subsequent, and an anomaly log is filtered based on the anomaly time instant, thereby effectively improving the analysis efficiency of a system fault cause.

To address the above-mentioned technical issues, an anomaly cause detection method is provided according to the present disclosure, including:
performing multiple types of anomaly detection operations on logs generated by a target system to obtain anomaly scores for respective detection types, and generating anomaly score time-series curves corresponding to the respective detection types;
performing correlation analysis on the anomaly score time-series curves, fusing correlated anomaly score time-series curves among the anomaly score time-series curves into a comprehensive anomaly score time-series curve, and determining a detection type corresponding to the comprehensive anomaly score time-series curve;
performing anomaly detection on the comprehensive anomaly score time-series curve, and determining an anomaly time instant at which an anomaly occurs in the comprehensive anomaly score time-series curve; and
searching for an anomaly log in the logs based on the anomaly time instant and the detection type corresponding to the comprehensive anomaly score time-series curve, to determine an anomaly cause of the target system based on the anomaly log.

In an embodiment, the performing correlation analysis on the anomaly score time-series curves includes:
performing Spearman correlation analysis on the anomaly score time-series curves to determine correlations between the anomaly score time-series curves.

In an embodiment, the fusing correlated anomaly score time-series curves among the anomaly score time-series curves into a comprehensive anomaly score time-series curve includes:
adding the correlated anomaly score time-series curves to a correlation group, and performing normalization on the anomaly score time-series curves in the correlation group; and
performing superimposing and averaging on the normalized anomaly score time-series data curves in the correlation group to obtain the comprehensive anomaly score time-series curve.

In an embodiment, the performing anomaly detection on the comprehensive anomaly score time-series curve, and determining an anomaly time instant at which an anomaly occurs in the comprehensive anomaly score time-series curve includes:
performing a wavelet transform on the comprehensive anomaly score time-series curve to determine a major rising edge in the comprehensive anomaly score time-series curve; and
determining a time instant corresponding to the major rising edge as the anomaly time instant.

In an embodiment, the performing multiple types of anomaly detection operations on logs generated by a target system to obtain anomaly scores for respective detection types includes at least one of:
aggregating the logs to form a log sequence, and inputting the log sequence to a pre-trained log sequence detection model to obtain an anomaly score for a log sequence detection, wherein the pre-trained log sequence detection model is trained with a preset normal log sequence, and the anomaly score for the log sequence detection represents a degree to which the log sequence deviates from the normal log sequence;

updating the logs to a log parsing tree, and determining a variation degree of the log parsing tree between adjacent detection time instants to obtain an anomaly score for a log structure detection;

determining, based on preset log categories to which the respective logs belong, a variation degree of an occurrence frequency of each preset log category of the preset log categories at a current detection time instant relative to an occurrence frequency of the preset log category at a previous detection time instant to obtain an anomaly score for a log category detection;

extracting a discrete variable from the logs, and determining a variation degree of an occurrence frequency of each preset value of preset values corresponding to the discrete variable at a current detection time instant relative to an occurrence frequency of the preset value at a previous detection time instant to obtain an anomaly score for a discrete variable detection;

extracting numerical values from the logs, performing clustering processing on the extracted numerical values to obtain a numerical cluster, and determining, among the extracted numerical values, a deviation degree of a numerical value outside the numerical cluster relative to the numerical cluster to obtain an anomaly score for a numerical clustering detection; or

converting multiple numerical values of a same type in the logs into a line graph, determining an outlier determination numerical interval based on the line graph, and calculating a ratio of a numerical value, among the multiple numerical values of the same type, which falls outside the outlier determination numerical interval to the multiple numerical values of the same type to obtain an anomaly score for a line graph detection.

In an embodiment, the searching for an anomaly log in the logs based on the anomaly time instant and the detection type corresponding to the comprehensive anomaly score time-series curve includes at least one of:
in response to the anomaly detection type being the log sequence detection, searching for an anomaly log sequence corresponding to the anomaly time instant, and determining, among the logs, a log that forms the anomaly log sequence as the anomaly log; or
in response to the anomaly detection type being the log structure detection, searching for an anomaly log parsing tree corresponding to the anomaly time instant, and searching for the anomaly log based on the anomaly log parsing tree; or
in response to the anomaly detection type being the log category detection, determining an anomaly log category based on an occurrence frequency of the preset log category at the anomaly time instant, and determining, among the logs, a log generated at the anomaly time instant and corresponding to the anomaly log category as the anomaly log; or
in response to the anomaly detection type being the discrete variable detection, determining an anomaly preset value based on an occurrence frequency of the preset value of the discrete variable at the anomaly time instant, and determining, among the logs, a log generated at the anomaly time instant and including the anomaly preset value as the anomaly log; or
in response to the anomaly detection type being the numerical clustering detection, determining an anomaly numerical value outside the numerical cluster at the anomaly time instant, and determining, among the logs, a log generated at the anomaly time instant and including the anomaly numerical value as the anomaly log; or
in response to the anomaly detection type being the line graph detection, searching for an anomaly line graph corresponding to the anomaly time instant, determining an anomaly numerical value in the anomaly line graph which falls outside the outlier determination numerical interval, and determining, among the logs, a log generated at the anomaly time instant and including the anomaly numerical value as the anomaly log.

In an embodiment, after the searching for an anomaly log in the logs based on the anomaly time instant and the detection type corresponding to the comprehensive anomaly score time-series curve, the anomaly cause detection method further includes:
generating a fault detection text based on the anomaly log;
inputting the fault detection text into a pre-trained language model to obtain a priority ranking of the anomaly log by the pre-trained language model, wherein the pre-trained language model is trained with a preset priority order for the anomaly log; and
outputting the priority ranking.

According to the present disclosure, an anomaly cause detection apparatus is further provided, including:
an anomaly detection module, configured to perform multiple types of anomaly detection operations on logs generated by a target system to obtain anomaly scores for respective detection types, and generate anomaly score time-series curves corresponding to the respective detection types;
a curve correlation module, configured to perform correlation analysis on the anomaly score time-series curves, fuse correlated anomaly score time-series curves among the anomaly score time-series curves into a comprehensive anomaly score time-series curve, and determine a detection type corresponding to the comprehensive anomaly score time-series curve;
an anomaly time instant detection module, configured to perform anomaly detection on the comprehensive anomaly score time-series curve, and determine an anomaly time instant at which an anomaly occurs in the comprehensive anomaly score time-series curve; and
a log searching module, configured to search for an anomaly log in the logs based on the anomaly time instant and the detection type corresponding to the comprehensive anomaly score time-series curve, to determine an anomaly cause of the target system based on the anomaly log.

According to the present disclosure, an electronic device is further provided, including:
a memory,
a processor, configured to implement the above-mentioned anomaly cause detection method when executing the computer program.

According to the present disclosure, a computer-readable storage medium is further provided. A computer-executable instruction is stored in the computer-readable storage medium, and the computer-executable instruction, when being loaded and executed by a processor, causes the processor to implement the above-mentioned anomaly cause detection method.

An anomaly cause detection method is provided according to the present disclosure, and the anomaly cause detection method includes: performing multiple anomaly detection operations on logs generated by a target system to obtain anomaly scores for respective detection types, and generating anomaly score time-series curves corresponding to the respective detection types; performing correlation analysis on the anomaly score time-series curves, fusing correlated anomaly score time-series curves among the anomaly score time-series curves into a comprehensive anomaly score time-series curve, and determining the detection type corresponding to the comprehensive anomaly score time-series curve; performing anomaly detection on the comprehensive anomaly score time-series curve, and determining an anomaly time instant at which an anomaly occurs in the comprehensive anomaly score time-series curve; and searching for an anomaly log in the logs based on the anomaly time instant and the detection type corresponding to the comprehensive anomaly score time-series curve, to determine an anomaly cause of the target system based on the anomaly log.

It can be seen that according to the present disclosure, multiple types of anomaly detection operations are performed on logs generated by a target system to obtain anomaly scores for respective detection types, and anomaly score time-series curves corresponding to the respective detection types are generated to determine abnormal fluctuations of the target system in respective detection dimensions. Correlation analysis is performed on the anomaly score time-series curves to determine a correlation between anomalies in different dimensions. Correlated anomaly score time-series curves are fused into a comprehensive anomaly score time-series curve. The detection type corresponding to the comprehensive anomaly score time-series curve is determined. Anomaly detection is performed on the comprehensive anomaly score time-series curve. An anomaly time instant at which an anomaly occurs in the comprehensive anomaly score time-series curve is determined, that is, correlation analysis is performed on the anomalies of the system in different dimensions. An anomaly log in the logs is determined based on the anomaly time instant and the detection type corresponding to the comprehensive anomaly score time-series curve, so as to determine an anomaly cause of the target system based on the anomaly log. Therefore, according to the present disclosure, the logs are detected from multiple dimensions, correlation analysis is performed on anomalies in the system in different dimensions by using correlation means, and the anomaly log is searched for based on the correlation analysis result, thereby effectively assisting a user in analyzing a root cause of a system fault. According to the present disclosure, an anomaly cause detection apparatus, an electronic device and a computer-readable storage medium are provided, which have the aforementioned beneficial effects.

### BRIEF DESCRIPTION OF THE DRAWINGS

In order to illustrate the technical solutions in the embodiments of the present disclosure or the conventional technology more clearly, drawings used for description of the embodiments or the conventional technology are introduced below briefly. Apparently, the drawings described below only show some embodiments of the present disclosure. Those skilled in the art may further obtain other drawings based on those drawings without creative work.

FIG. 1 is a flowchart of an anomaly cause detection method according to an embodiment of the present disclosure;

FIG. 2 is a schematic diagram of an anomaly cause detection procedure according to an embodiment of the present disclosure;

FIG. 3 is a structural block diagram of an anomaly cause detection apparatus according to an embodiment of the present disclosure; and

FIG. 4 is a structural block diagram of an electronic device according to an embodiment of the present disclosure.

### DETAILED DESCRIPTION

The technical solutions of the embodiments of the present disclosure are described clearly and completely as follows in combination with the drawings of these embodiments for a clear understanding of the purposes, technical solutions and advantages of the present disclosure. Apparently, the embodiments described are only some, not all of the embodiments of the present disclosure. All other embodiments obtained by those of ordinary skill in the art without creative work based on the embodiments of the present disclosure are within the scope of protection of the present disclosure.

In modern large-scale computing environment, the vast amount of logs generated by systems provides basic data for fault detection and system monitoring. However, conventional rule-based log analysis methods mostly adopt single-dimensional rule detection approaches, which only have limited detection capabilities and struggle to handle multi-dimensional anomaly correlations in complex systems. In addition, related technologies are inefficient in locating the root causes of anomalies, especially with limited capability to filter effective information from large volumes of log data, and thus failing to assist users in analyzing the specific causes of system anomalies.

In view of this, to address the technical issue of how to effectively assist a user in analyzing a system fault cause, an anomaly cause detection method is provided in the present disclosure. Anomaly score time-series curves may be generated through multiple detection operations, which are different from each other, on logs of a target system. A comprehensive anomaly score time-series curve is generated by using correlated anomaly score time-series curves based on curve correlation. An anomaly time instant may be identified within the comprehensive anomaly score time-series curve, and an anomaly cause of the target system is rapidly analyzed in combination with an anomaly log, thereby effectively improving the analysis efficiency for the system fault cause.

It should be noted that, the above-mentioned target system refers to a system, monitored by an anomaly detection system implementing the method, which may be any system capable of generating logs, such as a network system or an Internet of Things (IoT) system. The log involved may be a network traffic log or an IoT device log.

The anomaly cause detection method provided by the present disclosure is described in the following. For the sake of understanding, reference is made to FIG. 1, which is a flowchart of an anomaly cause detection method according to an embodiment of the present disclosure. The anomaly cause detection method includes the following steps S101 to S104.

In S101, multiple anomaly detection operations are performed on logs generated by a target system to obtain anomaly scores for respective detection types, and anomaly score time-series curves corresponding to the respective detection types are generated.

In this step, the multiple types of anomaly detection operations may be firstly performed on the logs (e.g., a log line) generated by the target system to perform preliminary anomaly detection on the target system from different perspectives and dimensions, so as to obtain the anomaly scores corresponding to the different detection types. The detection type refers to a type of the anomaly detection operation. The anomaly score herein represents an anomaly degree of the target system in a single detection dimension. A higher anomaly score indicates a more severe anomaly, and a lower anomaly score indicates a milder anomaly. Subsequently, the anomaly scores at multiple time instants may be curve-fitted to obtain anomaly score time-series curves (respectively generated based on anomaly score time-series data sets) corresponding to the respective anomaly detection types. The anomaly score time-series curves each reflect abnormal fluctuation of the target system in the single detection dimension.

The timing for triggering the anomaly detection operation in this embodiment may be periodically detecting the log generated by the target system within each periodic time interval. This embodiment is not intended to limit the specific value of the periodic time interval. For example, detection is performed on the log which is generated by the target system at intervals of 10 minutes for the preceding 10-minute period, or at the end of each day for the log generated that day.

Additionally, this embodiment is not intended to limit the specific anomaly detection operations. The operations may be determined based on actual application requirements, and may further refer to the descriptions in subsequent embodiments.

In S102, correlation analysis is performed on the anomaly score time-series curves, the correlated anomaly score time-series curves are fused into a comprehensive anomaly score time-series curve, and the detection type corresponding to the comprehensive anomaly score time-series curve is determined.

In this step, correlation between the anomaly score time-series curves may be firstly determined, and the anomaly score time-series curves may be divided into different correlation groups based on the correlation such that the anomaly score time-series curves within each group are interrelated, while the anomaly score time-series curves in different groups are relatively independent. In other words, in this step, interrelated abnormal fluctuations are identified from the abnormal fluctuations of the target system across different dimensions, so as to perform a comprehensive analysis on the interrelated abnormal fluctuations. The logs recording various anomalies may be different. The interrelated logs are rapidly filtered from the logs through correlation analysis in this embodiment, so as to improve the flexibility and reliability of assistance in the root cause analysis for system anomalies.

It should be noted that, this embodiment is not intended to limit how correlation between the anomaly score time-series curves are determined. For example, correlation analysis may be performed on the respective anomaly score time-series curves to obtain correlation values of the curves, and then correlated curves may be determined based on the correlation values. Likewise, this embodiment is not intended to limit specific correlation analysis method, such as Pearson correlation analysis and Spearman correlation analysis. In view of the fact that the Spearman correlation analysis has better adaptability to various data types continuous, is applicable to discrete, and ordinal variables and exhibits strong robustness and flexibility, the Spearman correlation analysis is performed on anomaly score time-series curves to determine the correlation between the anomaly score time-series curves.

Based on this, performing correlation analysis on the anomaly score time-series curves includes the following step 11.

In step 11, Spearman correlation analysis is performed on anomaly score time-series curves to determine the correlation between the anomaly score time-series curves.

Furthermore, in this step, the anomaly score time-series curves within a same correlation group are fused into a comprehensive anomaly score time-series curve to uniformly perform anomaly detection based on the comprehensive anomaly score time-series curve. In addition, to facilitate log backtracking search, in this step, detection types corresponding to the anomaly score time-series curves used in the fusion are determined as a detection type corresponding to the comprehensive anomaly score time-series curve. In an embodiment, for the sake of highlighting data features, normalization is performed on the respective anomaly score time-series curves before the curves are fused. Subsequently, superimposing and averaging may be performed on the normalized anomaly score time-series curves to obtain the comprehensive anomaly score time-series curve.

Based on this, the fusing the correlated anomaly score time-series curves into a comprehensive anomaly score time-series curve includes the following steps 21 and 22.

In step 21, the correlated anomaly score time-series curves are added to the correlation group, and normalization is performed on the anomaly score time-series curves in the correlation group.

In step 22, superimposing and averaging are performed on the normalized anomaly score time-series curves in the correlation group to obtain the comprehensive anomaly score time-series curve.

In S103, anomaly detection is performed on the comprehensive anomaly score time-series curve, and an anomaly time instant at which an anomaly occurs is determined in the comprehensive anomaly score time-series curve.

In this step, anomaly detection may be performed on the comprehensive anomaly score time-series curve to determine the anomaly time instant at which the anomaly occurs in the comprehensive anomaly score time-series curve. This embodiment is not intended to limit a specific procedure of anomaly detection, and the specific procedure of anomaly detection may be determined based on actual application requirements. For example, in practice, attention is paid to abrupt variations of anomaly scores, particularly a sudden and significant increase in the anomaly score. In this embodiment, a wavelet transform (e.g., by using the Ricker wavelet function) may be performed on the comprehensive anomaly score time-series curve to determine a major rising edge in the comprehensive anomaly score time-series curve. For example, the wavelet transform is performed on the comprehensive anomaly score time-series curve to obtain a wavelet curve. A curve interval corresponding to the abrupt variation of waveform is identified in the wavelet curve, and the major rising edge is determined within the curve interval. For example, within the curve interval, a position where a slope of the curve is positive and stops increasing is determined as the major rising edge. A time instant corresponding to the major rising edge may be determined as the anomaly time instant.

Based on this, the performing anomaly detection on the comprehensive anomaly score time-series curve, and determining an anomaly time instant at which an anomaly occurs in the comprehensive anomaly score time-series curve includes the following steps 31 and 32.

In step 31, the wavelet transform is performed on the comprehensive anomaly score time-series curve to determine the major rising edge in the comprehensive anomaly score time-series curve.

In step 32, the time instant corresponding to the major rising edge is determined as the anomaly time instant.

In this embodiment, the wavelet transform is employed to determine the major rising edge of the comprehensive anomaly score time-series curve, to accurately locate a starting time point of the anomaly, effectively filtering out transient spike noise, and thus improving accuracy of anomaly detection.

In S104, an anomaly log is searched for in the logs based on the anomaly time instant and the detection type corresponding to the comprehensive anomaly score time-series curve to determine an anomaly cause of the target system based on the anomaly log.

In this step, the anomaly log may be searched for in the logs based on the anomaly time instant and the detection type corresponding to the comprehensive anomaly score time-series curve obtained from the previous step. Data recorded in the anomaly log causes the anomaly in the comprehensive anomaly score time-series curve of the correlation group to which the anomaly log belongs. Therefore, the anomaly log assists operation and maintenance personnel in analyzing the anomaly cause of the target system in a better way, thereby improving the reliability of assistance.

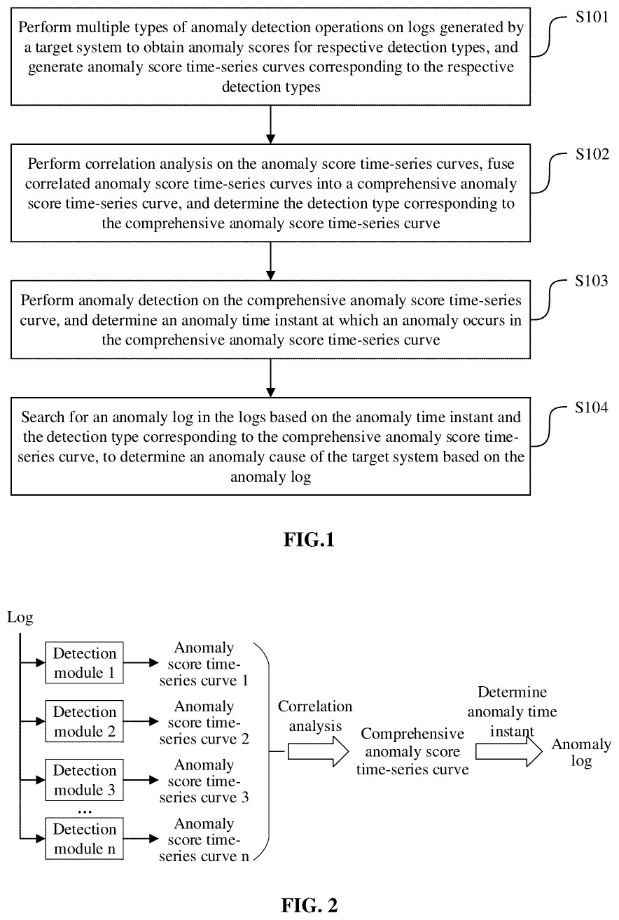

Furthermore, for the sake of understanding a specific procedure of the anomaly cause detection method, reference is made to FIG. 2, which is a schematic diagram of an anomaly cause detection procedure according to an embodiment of the present disclosure. Different anomaly detection operations are configured in respective detection modules for performing anomaly detection on the logs from different dimensions. Abnormal scores generated by each of the respective modules at different time instants are fitted into an anomaly score time-series curve. Correlation analysis may be performed on the anomaly score time-series curves, and the correlated anomaly score time-series curves are fused into the comprehensive anomaly score time-series curve. Anomaly detection may be performed on the comprehensive anomaly score time-series curve to determine the anomaly time instant at which the anomaly occurs, so as to filter the anomaly log based on the anomaly time instant.

Based on the above-mentioned embodiment, according to the present disclosure, multiple types of anomaly detection operations are performed on logs generated by a target system to obtain anomaly scores for respective detection types, and anomaly score time-series curves corresponding to the respective detection types are generated to determine abnormal fluctuations of the target system in respective detection dimensions. Correlation analysis is performed on the anomaly score time-series curves to determine a correlation between anomalies in different dimensions. Correlated anomaly score time-series curves are fused into a comprehensive anomaly score time-series curve. The detection type corresponding to the comprehensive anomaly score time-series curve is determined. Anomaly detection is performed on the comprehensive anomaly score time-series curve. An anomaly time instant at which an anomaly occurs in the comprehensive anomaly score time-series curve is determined, that is, correlation analysis is performed on the anomalies of the system in different dimensions. An anomaly log in the logs is determined based on the anomaly time instant and the detection type corresponding to the comprehensive anomaly score time-series curve, so as to determine an anomaly cause of the target system based on the anomaly log. Therefore, according to the present disclosure, the logs are detected from multiple dimensions, correlation analysis is performed on anomalies in the system in different dimensions by using correlation means, and the anomaly log is searched for based on the correlation analysis result, thereby effectively assisting a user in analyzing a root cause of a system fault.

Based on the above-mentioned embodiment, the different anomaly detection operations and the log backtracking search methods corresponding to the respective anomaly detection operations are described in the following. In an embodiment, the performing multiple types of anomaly detection operations on logs generated by a target system to obtain anomaly scores for respective detection types may include the following step 41.

In step 41, the logs are aggregated to form a log sequence, and the log sequence is input to a pre-trained log sequence detection model to obtain an anomaly score for a log sequence detection. The pre-trained log sequence detection model is trained with a preset normal log sequence, and the anomaly score for the log sequence detection represents a degree to which the log sequence deviates from the normal log sequence.

In this embodiment, detection may be performed on the log sequence by using the pre-trained log sequence detection model, and the pre-trained log sequence detection model is trained with the preset normal log sequence. Therefore, the pre-trained log sequence detection model compares the inputted log sequence with the normal log sequence the model is trained with, and generate the anomaly score for the log sequence detection. The anomaly score represents the degree to which the log sequence deviates from the normal log sequence. Therefore, in this embodiment, anomalies are detected from the perspective of log sequence in a timely manner.

It should be noted that, this embodiment is not intended to limit a specific type of the pre-trained log sequence detection model. For example, it may be a log BERT model. For specific log sequence detection procedure, reference may be made to related technologies of Log BERT. Likewise, this embodiment is not intended to limit how to convert and combine the logs into the log sequence. For example, a DRAIN algorithm may be used to convert the logs into log tokens, and to combine the log tokens into the log sequence. The DRAIN algorithm is a fixed-depth tree-based online log parsing algorithm.

The log backtracking search method corresponding to the log sequence detection is described in the following. Based on this, the searching for an anomaly log in the logs based on the anomaly time instant and the detection type corresponding to the comprehensive anomaly score time-series curve may include the following step 51.

In step 51, in a case that the anomaly detection type is the log sequence detection, an anomaly log sequence corresponding to the anomaly time instant is searched for, and among the logs, a log that forms the anomaly log sequence is determined as the anomaly log.

In this embodiment, if the anomaly detection type is the log sequence detection, the anomaly log sequence corresponding to the anomaly time instant is searched for, and the log forming the anomaly log sequence is determined as the anomaly log to rapidly implement the log backtracking search.

In an embodiment, the performing multiple types of anomaly detection operations on logs generated by a target system to obtain anomaly scores for respective detection types may include the following step 61.

In step 61, the logs are updated to a log parsing tree, and a variation degree of the log parsing tree between adjacent detection time instants is determined to obtain an anomaly score for a log structure detection.

In this embodiment, the variation of the log parsing tree at different detection time instants are detected. The log parsing tree is a multi-level hierarchical structure constructed based on the logs, and is configured for log parsing. The log parsing tree may be generated by using the DRAIN algorithm. For specific generation methods, reference may be made to related technologies of the DRAIN algorithm. In an embodiment, the logs are updated to the log parsing tree, and the variation degree of the log parsing tree between adjacent detection time instants is detected to obtain the anomaly score for the log structure detection. Therefore, in this embodiment, abrupt variations of the log parsing tree are determined from the perspective of log structure in a timely manner.

It should be noted that, this embodiment is not intended to limit how to calculate a variation degree of the log parsing tree between adjacent detection time instants. For example, a Jensen-Shannon drift divergence (JSD) algorithm may be adopted for calculation.

The log backtracking search method corresponding to the log structure detection is described in the following. Based on this, the searching for an anomaly log in the logs based on the anomaly time instant and the detection type corresponding to the comprehensive anomaly score time-series curve may include the following step 71.

In step 71, in a case that the anomaly detection type is the log structure detection, an anomaly log parsing tree corresponding to the anomaly time instant is searched for, and the anomaly log is searched for based on the anomaly log parsing tree.

In this embodiment, if the anomaly detection type is the log structure detection, the anomaly log parsing tree corresponding to the anomaly time instant may be searched for. Subsequently, the log causing the abrupt variation in the anomaly log parsing tree at the anomaly time instant may be determined as the anomaly log to rapidly implement the log backtracking search.

In an embodiment, the performing multiple types of anomaly detection operations on logs generated by a target system to obtain anomaly scores for respective detection types may include the following step 81.

In step 81, based on preset log categories to which the respective logs belong, a variation degree of an occurrence frequency of each preset log category of the preset log categories at a current detection time instant relative to an occurrence frequency of the preset log category at a previous detection time instant, to obtain an anomaly score for a log category detection.

In this embodiment, a frequency variation of each of the preset log categories is detected, and the frequency variation is quantified as the anomaly score. In an embodiment, based on preset log categories to which the respective logs belong, the variation degree of the occurrence frequency of each preset log category of the preset log categories at the current detection time instant relative to the occurrence frequency of the preset log category at the previous detection time instant may be determined to obtain the anomaly score for the log category detection. The occurrence frequency of the preset log category at each detection time instant may specifically refer to the occurrence frequency of the preset log category within a preset time interval prior to the detection time instant. Therefore, in this embodiment, abrupt variations in the log category distribution are determined from the perspective of log category (e.g. based on a top field) in a timely manner.

It should be noted that, this embodiment is not intended to limit specific preset log categories, and the preset log categories may be set based on actual application requirements. Likewise, this embodiment is not intended to limit how to calculate the variation degree of the preset log category occurrence frequency. For example, the above-mentioned JSD algorithm may be adopted for calculation.

The log backtracking search method corresponding to the log category detection is described in the following. Based on this, the searching for an anomaly log in the logs based on the anomaly time instant and the detection type corresponding to the comprehensive anomaly score time-series curve may include the following step 91.

In step 91, in a case that the anomaly detection type is the log category detection, an anomaly log category is determined based on an occurrence frequency of the preset log category at the anomaly time instant, and among the logs, a log generated at the anomaly time instant and corresponding to the anomaly log category is determined as the anomaly log.

In this embodiment, if the anomaly detection type is the log category detection, the anomaly log category is determined based on the occurrence frequency of the preset log category at the anomaly time instant. For example, the log category with the abrupt variation (sudden/crease/sudden decrease) in the occurrence frequency may be determined as the anomaly log category. The determination of the abrupt variation may be processed based on numerical relationship between the occurrence frequency and a preset threshold. Subsequently, a log generated at the anomaly time instant and corresponding to the anomaly log category may be determined as the anomaly log to rapidly implement the log backtracking search.

In an embodiment, the performing multiple types of anomaly detection operations on logs generated by a target system to obtain anomaly scores for respective detection types may include the following step 101.

In 101, a discrete variable is extracted from the logs, and a variation degree of an occurrence frequency of each preset value of preset values corresponding to the discrete variable at a current detection time instant relative to an occurrence frequency of the preset value at a previous detection time instant to obtain an anomaly score for a discrete variable detection.

In this embodiment, the discrete variable refers to a variable having multiple preset values. The target system selects the numerical value for the discrete variable from the multiple preset values. For such numerical values, the variation degree of the occurrence frequency of each preset value of the preset values corresponding to the discrete variable at a current detection time instant relative to the occurrence frequency of the preset value at a previous detection time instant may be determined to obtain the anomaly score for the discrete variable detection. The occurrence frequency of each of the present values at each detection time instant may specifically refer to an occurrence frequency of the present value within a preset time interval prior to the detection time instant. Therefore, in this embodiment, abnormal variations in the value of the discrete variable are detected from the perspective of discrete variable in a timely manner.

It should be noted that, this embodiment is not intended to limit how to calculate the variation degree of the occurrence frequency the value of the discrete variable. For example, the above-mentioned JSD algorithm may further be adopted for calculation.

The log backtracking search method corresponding to the discrete variable detection is described in the following. The searching for an anomaly log in the logs based on the anomaly time instant and the detection type corresponding to the comprehensive anomaly score time-series curve may include the following step 111.

In step 111, in a case that the anomaly detection type is the discrete variable detection, an anomaly preset value is determined based on an occurrence frequency of the preset value of the discrete variable at the anomaly time instant, and among the logs, a log generated at the anomaly time instant and including the anomaly preset value is determined as the anomaly log.

In this embodiment, if the anomaly detection type is the discrete variable detection, the anomaly preset value is determined based on the occurrence frequency of the preset value of the discrete variable at the anomaly time instant. For example, the preset value with the abrupt variation (sudden/crease/sudden decrease) in the occurrence frequency may be determined as the anomaly preset value. The determination of the abrupt variation may be processed based on numerical relationship between the occurrence frequency and a preset threshold. Subsequently, a log generated at the anomaly time instant and including the anomaly preset value is determined as the anomaly log to rapidly implement the log backtracking search.

In an embodiment, the performing multiple types of anomaly detection operations on logs generated by a target system to obtain anomaly scores for respective detection types may include the following step 121.

In step 121, numerical values are extracted from the logs, clustering processing is performed on the extracted numerical values to obtain a numerical cluster, and among the extracted numerical values, a deviation degree of a numerical value outside the numerical cluster relative to the numerical cluster is determined to obtain an anomaly score for a numerical clustering detection.

In this embodiment, clustering detection is performed on the numerical values. Outliers of the numerical values are detected based on the numerical cluster obtained by clustering, such as calculation of the deviation degree of a numerical value outside the numerical cluster relative to the numerical cluster, to obtain the anomaly score for the numerical clustering detection. Therefore, in this embodiment, abnormal outliers of the numerical values are determined from the perspective of numerical cluster in a timely manner.

It should be noted that, this embodiment is not intended to limit how to perform clustering processing on numerical values. Related technologies in clustering algorithms, such as a density-based spatial clustering of applications with noise (DBSCAN) algorithm, may be adopted for clustering processing.

The log backtracking search method corresponding to the numerical clustering detection is described in the following. Based on this, the searching for an anomaly log in the logs based on the anomaly time instant and the detection type corresponding to the comprehensive anomaly score time-series curve may include the following step 131.

In S131, in a case that the anomaly detection type is the numerical clustering detection, an anomaly numerical value outside the numerical cluster at the anomaly time instant is determined, and among the logs, a log generated at the anomaly time instant and including the anomaly numerical value is determined as the anomaly log.

In this embodiment, if the anomaly detection type is the numerical clustering detection, a target numerical cluster at the anomaly time instant may be searched for and the anomaly numerical value outside the numerical cluster may be determined. The log generated at the anomaly time instant and including the anomaly numerical value is determined as the anomaly log to rapidly implement the log backtracking search.

In an embodiment, the performing multiple types of anomaly detection operations on logs generated by a target system to obtain anomaly scores for respective detection types may include the following step 141.

In step 141, multiple numerical values of a same type in the logs are converted into a line graph. An outlier determination numerical interval is determined based on the line graph, and a ratio of a numerical value among the multiple numerical values of the same type which falls outside the outlier determination numerical interval to the multiple numerical values of the same type is determined to obtain an anomaly score for a line graph detection.

In this embodiment, numerical values of a fluctuating type may be fitted into a line graph to reflect fluctuations of the numerical values over time. The outlier determination numerical interval may be determined based on the line graph. The outlier determination numerical interval is a numerical interval used for determining outliers. For example, numerical values within the interval are non-outliers, and numerical values outside the interval are outliers. In brief, the outlier determination numerical interval is used for determining numerical values with abnormal fluctuation amplitudes. Therefore, in this embodiment, abnormal fluctuations of the numerical values of the fluctuating type may be determined from the perspective of line graph (e.g. based on a line graph of log rate) in a timely manner.

It should be noted that the outlier determination numerical interval may be constructed through various methods. For example, the outlier determination numerical interval may be constructed based on a prediction interval algorithm (e.g., a Facebook Prophet algorithm). The outlier determination numerical interval may further be obtained by calculating a standard deviation of the numerical values composing the line graph and determining a preset multiple of the standard deviation as an upper/lower limit of the outlier determination numerical interval.

The log backtracking search method corresponding to the line graph detection is described in the following. Based on this, the searching for an anomaly log in the logs based on the anomaly time instant and the detection type corresponding to the comprehensive anomaly score time-series curve may include the following step 151.

In step 151, in a case that the anomaly detection type is the line graph detection, an anomaly line graph corresponding to the anomaly time instant is searched for, and an anomaly numerical value in the anomaly line graph which falls outside the outlier determination numerical interval is determined. Among the logs, a log generated at the anomaly time instant and including the anomaly numerical value is determined as the anomaly log.

In this embodiment, if the anomaly detection type is the line graph detection, the anomaly line graph corresponding to the anomaly time instant may be searched for, and the anomaly numerical value in the anomaly line graph which falls outside the outlier determination numerical interval is determined. A log generated at the anomaly time instant and including the anomaly numerical value is determined as the anomaly log to rapidly implement the log backtracking search.

It should be noted that, the aforementioned anomaly detection operations and log backtracking search methods may be selectively employed. In addition to the above-mentioned anomaly detection operations and the log backtracking search methods, other anomaly detection operations and log backtracking search methods may further be selected according to actual requirements and be set according to actual application requirements.

Based on the above-mentioned embodiments, in view of the fact that there may be a vast amount of anomaly logs, in an embodiment, a pre-trained language model such as a large language model (LLM) may be employed to assist a user in viewing and filtering important anomaly logs. The pre-trained language model may be used to automatically sort the anomaly logs.

A specific procedure of sorting the anomaly logs is described as follows. Based on this, after the searching for an anomaly log in the logs based on the anomaly time instant and the anomaly detection types corresponding to the anomaly score time-series curves in the correlation group, the anomaly cause detection method may further include the following steps 131 to 133.

In step 131, a fault detection text is generated based on the anomaly logs.

In this embodiment, to facilitate the pre-trained language model in identifying the anomaly logs, the fault detection text (e.g., a prompt) is generated in advance based on the anomaly logs. The fault detection text may include a preset requirement field, such as indicating the need to sort the anomaly logs. Therefore, when identifying the requirement field, the pre-trained language model automatically sorts the anomaly logs.

In step 132, the fault detection text is inputted into the pre-trained language model, so as to obtain a priority ranking of the anomaly logs by the pre-trained language model. The pre-trained language model is trained with a preset priority order for the anomaly logs.

In this step, the fault detection text may be inputted into the pre-trained language model, so as to obtain the priority ranking of the anomaly logs by the pre-trained language model. The pre-trained language model is trained with the preset priority order for the anomaly logs. In other words, in this embodiment, the preset priority order is determined in advance for various logs, and the pre-trained language model is controlled to be trained with the preset priority order. Therefore, in subsequent online inference procedure, the pre-trained language model sorts inputted anomaly logs according to the preset priority order with which the pre-trained language model is trained.

It should be noted that, this embodiment is not intended to limit a procedure of training the pre-trained language model, and reference may be made to related technologies of the LLM.

In step 133, the priority ranking is outputted.

An anomaly cause detection apparatus, an electronic device, a computer program product and a computer-readable storage medium according to the embodiments of the present disclosure are described as follows. The anomaly cause detection apparatus, the electronic device, the computer program product and the computer-readable storage medium described below may be cross-referenced with the aforementioned anomaly cause detection method.

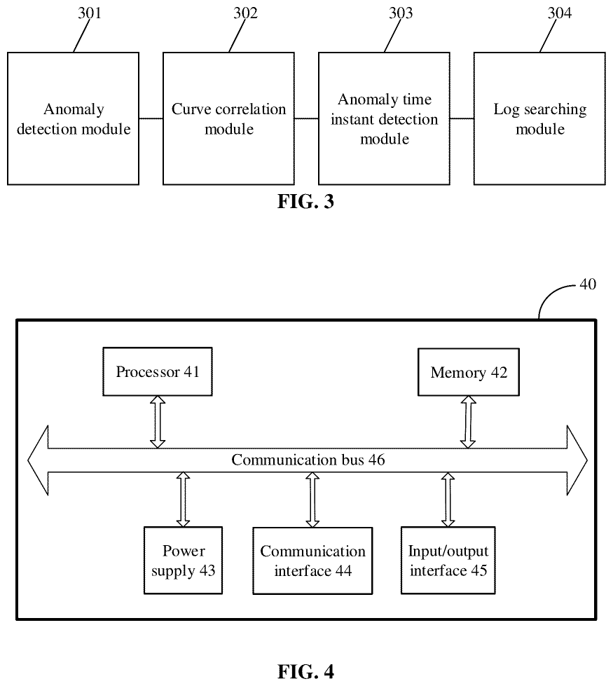

Reference is made to FIG. 3, which is a structural block diagram of an anomaly cause detection apparatus according to an embodiment of the present disclosure. The anomaly cause detection apparatus includes an anomaly detection module 301, a curve correlation module 302, an anomaly time instant detection module 303, and a log searching module 304.

The anomaly detection module 301 is configured to perform multiple anomaly detection operations on logs generated by a target system to obtain anomaly scores for respective detection types, and generate anomaly score time-series curves corresponding to the respective detection types.

The curve correlation module 302 is configured to perform correlation analysis on the anomaly score time-series curves, fuse correlated anomaly score time-series curves among the anomaly score time-series curves into a comprehensive anomaly score time-series curve, and determine the detection type corresponding to the comprehensive anomaly score time-series curve.

The anomaly time instant detection module 303 is configured to perform anomaly detection on the comprehensive anomaly score time-series curve, and determine an anomaly time instant at which an anomaly occurs in the comprehensive anomaly score time-series curve.

The log searching module 304 is configured to search for an anomaly log in the logs based on the anomaly time instant and the detection type corresponding to the comprehensive anomaly score time-series curve, to determine an anomaly cause of the target system based on the anomaly log.

In an embodiment, the curve correlation module 302 includes a correlation analysis sub-module.

The correlation analysis sub-module is configured to perform Spearman correlation analysis on the anomaly score time-series curves to determine correlations between the anomaly score time-series curves.

In an embodiment, the anomaly time instant detection module 303 includes a normalization sub-module and a superimposing sub-module.

The normalization sub-module is configured to add the correlated anomaly score time-series curves to a correlation group, and perform normalization on the anomaly score time-series curves in the correlation group.

The superimposing sub-module is configured to perform superimposing and averaging on the normalized anomaly score time-series data curves in the correlation group to obtain the comprehensive anomaly score time-series curve.

In an embodiment, the anomaly time instant detection module 303 includes an anomaly detection sub-module and an anomaly time instant determination sub-module.

The anomaly detection sub-module is configured to perform a wavelet transform on the comprehensive anomaly score time-series curve to determine a major rising edge in the comprehensive anomaly score time-series curve.

The anomaly time instant determination sub-module is configured to determine a time instant corresponding to the major rising edge as the anomaly time instant.

In an embodiment, the anomaly detection module 301 includes at least one of: a log sequence detection sub-module, a log structure detection sub-module, a log category detection sub-module, a discrete variable detection sub-module, a clustering detection sub-module, or a line graph detection sub-module.

The log sequence detection sub-module is configured to aggregate the logs to form a log sequence, and input the log sequence to a pre-trained log sequence detection model to obtain an anomaly score for a log sequence detection. The pre-trained log sequence detection model is trained with a preset normal log sequence, and the anomaly score for the log sequence detection represents a degree to which the log sequence deviates from the normal log sequence.

The log structure detection sub-module is configured to update the logs to a log parsing tree, and determine a variation degree of the log parsing tree between adjacent detection time instants to obtain an anomaly score for a log structure detection.

The log category detection sub-module is configured to determine, based on preset log categories to which the respective logs belong, a variation degree of an occurrence frequency of each preset log category of the preset log categories at a current detection time instant relative to an occurrence frequency of the preset log category at a previous detection time instant to obtain an anomaly score for a log category detection.

The discrete variable detection sub-module is configured to extract a discrete variable from the logs, and determine a variation degree of an occurrence frequency of each preset value of preset values corresponding to the discrete variable at a current detection time instant relative to an occurrence frequency of the preset value at a previous detection time instant to obtain an anomaly score for a discrete variable detection.

The numerical clustering detection sub-module is configured to extract numerical values from the log, perform clustering processing on the extracted numerical values to obtain a numerical cluster; and determine, among the extracted numerical values, a deviation degree of a numerical value outside the numerical cluster relative to the numerical cluster to obtain an anomaly score for a numerical clustering detection.

The line graph detection sub-module is configured to convert multiple numerical values of a same type in the logs into a line graph, determine an outlier determination numerical interval based on the line graph, and calculate a ratio of a numerical value outside the outlier determination numerical interval to the multiple numerical values of the same type to obtain an anomaly score for a line graph detection.

In an embodiment, the log search module 304 includes at least one of: a first searching sub-module, a second searching sub-module, a third searching sub-module, a fourth searching sub-module, a fifth searching sub-module, or a sixth searching sub-module.

The first search sub-module is configured to, in response to the anomaly detection type being the log sequence detection, search for an anomaly log sequence corresponding to the anomaly time instant, and determine, among the logs, a log that forms the anomaly log sequence as the anomaly log.

The second search sub-module is configured to, in response to the anomaly detection type being the log structure detection, search for an anomaly log parsing tree corresponding to the anomaly time instant, and search for the anomaly log based on the anomaly log parsing tree.

The third search sub-module is configured to, in response to the anomaly detection type being the log category detection, determine an anomaly log category based on the occurrence frequency of the preset log category at the anomaly time instant, and determine, among the logs, a log generated at the anomaly time instant and corresponding to the anomaly log category as the anomaly log.

The fourth search sub-module is configured to, in response to the anomaly detection type being the discrete variable detection, determine an anomaly preset value based on an occurrence frequency of the preset value of the discrete variable at the anomaly time instant, and determine, among the logs, a log generated at the anomaly time instant and including the anomaly preset value as the anomaly log.

The fifth search sub-module is configured to, in response to the anomaly detection type being the numerical clustering detection, determine an anomaly numerical value outside the numerical cluster at the anomaly time instant, and determine, among the logs, a log generated at the anomaly time instant and including the anomaly numerical value as the anomaly log.

The sixth search sub-module is configured to, in response to the anomaly detection type being the line graph detection, search for an anomaly line graph corresponding to the anomaly time instant, determine an anomaly numerical value in the anomaly line graph which falls outside the outlier determination numerical interval, and determine, among the logs, a log generated at the anomaly time instant and including the anomaly numerical value as the anomaly log.

In an embodiment, the anomaly cause detection apparatus further includes a text generation module, a ranking module and an outputting module.

The text generation module is configured to generate a fault detection text based on the anomaly log.

The ranking module is configured to input the fault detection text into a pre-trained language model to obtain a priority ranking of the anomaly log generated by the pre-trained language model. The pre-trained language model is trained with a preset priority order for the anomaly log.

The outputting module is configured to output the priority ranking.

Reference is made to FIG. 4, which is a structural block diagram of an electronic device according to an embodiment of the present disclosure. In an embodiment of the present disclosure, an electronic device 40 is provided, including a processor 41 and a memory 42. The memory 42 is configured to store a computer program. The processor 41 is configured to implement the anomaly cause detection method according to the above-mentioned embodiments when executing the computer program.

A specific procedure of the aforementioned anomaly cause detection method may be referred to the corresponding content provided in the above embodiments, which are not described here.

Moreover, the memory 42, as a carrier for resource storage, may be a read-only memory (ROM), a random access memory (RAM), a disk, an optical disk and the like. The storage modes of the memory 42 include temporary storage or permanent storage.

In addition, the electronic device 40 further includes a power supply 43, a communication interface 44, an input/output interface 45, and a communication bus 46. The power supply 43 is used to provide operation voltage for each hardware device on the electronic device 40. The communication interface 44 is for creating a data transmission channel between the electronic device 40 and an external device, and follows any communication protocol applicable to the technical solutions of the present disclosure, which is not specifically limited here. The input/output interface 45 is used to obtain inputted data or output data, and its specific interface type may be selected based on specific application requirements, which is not specifically limited here.

Furthermore, multiple electronic devices described above may also be clustered to jointly implement the aforementioned anomaly cause detection method. For example, part of the electronic devices are configured to perform anomaly detection operations, and another part of the electronic devices are configured to perform correlation analysis on the anomaly score time-series curves and to perform anomaly detection on the comprehensive anomaly score time-series curve.

In an embodiment of the present disclosure, a computer program product including a computer program/an instruction is further provided. When executed by a processor, the computer program/the instruction causes the processor to implement the anomaly cause detection method as described in the above embodiments.

Since the embodiments related to the computer program product correspond to the embodiments related to the anomaly cause detection method, the description of the computer program product-related embodiments may be referred to the description of anomaly cause detection method-related embodiments, which are not described here.

In an embodiment of the present disclosure, a computer-readable storage medium having a computer program stored thereon is provided. When executed by a processor, the computer program causes the processor to implement the anomaly cause detection method as described in the above embodiment.

Since the embodiments related to the computer-readable storage medium correspond to those related to the anomaly cause detection method, the description of the computer-readable storage medium-related embodiments may be referred to the description of the anomaly cause detection method-related embodiments, which are not described here.

The embodiments in the description have been described in a progressive manner. What are emphasized in each embodiment refer to the differences from other embodiments. The same or similar parts among the embodiments may be referred to each other. For the apparatus disclosed in the embodiments, the description is relatively brief as it corresponds to the method disclosed in the embodiment. Reference may be made to the description of the method for relevant features.

Further, those skilled in the art can understand that the technical solutions can be realized by an electronic hardware, a computer software or a combination thereof in conjunction with various exemplary units and algorithm steps described in the embodiments of the present disclosure. To clearly illustrate the interchangeability of the hardware and the software, compositions and steps of each example have been generally described above based on functions. Whether these functions are implemented by a software or a hardware depends on the specific application of the technical solution and design constraints. Those skilled in the art may further implement the described function for each specific application in various ways. However, this implementation should not be interpreted as deviating from the scope of the present disclosure.

The technical solutions can be directly implemented in the form of a hardware, a software module performed by the processor or a combination thereof in conjunction with the methods or algorithm steps described in the embodiments of the present disclosure. The software module may be provided in a random access memory (RAM), an internal storage, an read-only memory (ROM), an electrically programmable ROM, an electrically erasable programmable ROM (EEPROM), a register, a hard disk, a removable disk, a CD-ROM or a storage medium in any other forms known in the art.

The above is detailed description for the anomaly cause detection method, apparatus, the electronic device and the storage medium provided by the present disclosure. Specific embodiments are taken to describe the principles and implementations of the present disclosure, and the above description of embodiments only intends to facilitate in understanding the methods and basic idea of the present disclosure. For those skilled in the art, various alternations and modifications may be made to the present disclosure without departing from the principles thereof, and these alternations and modifications also fall within the scope of protection of the present disclosure.

1. An anomaly cause detection method, comprising:
performing a plurality of types of anomaly detection operations on logs generated by a target system to obtain anomaly scores for respective detection types, and generating anomaly score time-series curves corresponding to the respective detection types;
performing correlation analysis on the anomaly score time-series curves, fusing correlated anomaly score time-series curves among the anomaly score time-series curves into a comprehensive anomaly score time-series curve, and determining a detection type corresponding to the comprehensive anomaly score time-series curve;
performing anomaly detection on the comprehensive anomaly score time-series curve, and determining an anomaly time instant at which an anomaly occurs in the comprehensive anomaly score time-series curve; and
searching for an anomaly log in the logs based on the anomaly time instant and the detection type corresponding to the comprehensive anomaly score time-series curve, to determine an anomaly cause of the target system based on the anomaly log.

2. The anomaly cause detection method according to claim 1, wherein the performing correlation analysis on the anomaly score time-series curves comprises:
performing Spearman correlation analysis on the anomaly score time-series curves to determine correlations between the anomaly score time-series curves.

3. The anomaly cause detection method according to claim 1, wherein the fusing correlated anomaly score time-series curves among the anomaly score time-series curves into a comprehensive anomaly score time-series curve comprises:
adding the correlated anomaly score time-series curves to a correlation group, and performing normalization on the anomaly score time-series curves in the correlation group; and
performing superimposing and averaging on the normalized anomaly score time-series data curves in the correlation group to obtain the comprehensive anomaly score time-series curve.

4. The anomaly cause detection method according to claim 1, wherein the performing anomaly detection on the comprehensive anomaly score time-series curve, and determining an anomaly time instant at which an anomaly occurs in the comprehensive anomaly score time-series curve comprises:
performing a wavelet transform on the comprehensive anomaly score time-series curve to determine a major rising edge in the comprehensive anomaly score time-series curve; and
determining a time instant corresponding to the major rising edge as the anomaly time instant.

5. The anomaly cause detection method according to claim 1, wherein the performing a plurality of types of anomaly detection operations on logs generated by a target system to obtain anomaly scores for respective detection types comprises at least one of:
aggregating the logs to form a log sequence, and inputting the log sequence to a pre-trained log sequence detection model to obtain an anomaly score for a log sequence detection, wherein the pre-trained log sequence detection model is trained with a preset normal log sequence, and the anomaly score for the log sequence detection represents a degree to which the log sequence deviates from the normal log sequence;
updating the logs to a log parsing tree, and determining a variation degree of the log parsing tree between adjacent detection time instants to obtain an anomaly score for a log structure detection;
determining, based on preset log categories to which the respective logs belong, a variation degree of an occurrence frequency of each preset log category of the preset log categories at a current detection time instant relative to an occurrence frequency of the preset log category at a previous detection time instant to obtain an anomaly score for a log category detection;
extracting a discrete variable from the logs, and determining a variation degree of an occurrence frequency of each preset value of preset values corresponding to the discrete variable at a current detection time instant relative to an occurrence frequency of the preset value at a previous detection time instant to obtain an anomaly score for a discrete variable detection;
extracting numerical values from the logs, performing clustering processing on the extracted numerical values to obtain a numerical cluster, and determining, among the extracted numerical values, a deviation degree of a numerical value outside the numerical cluster relative to the numerical cluster to obtain an anomaly score for a numerical clustering detection; or
converting a plurality of numerical values of a same type in the logs into a line graph, determining an outlier determination numerical interval based on the line graph, and calculating a ratio of a numerical value, among the plurality of numerical values of the same type, which falls outside the outlier determination numerical interval to the plurality of numerical values of the same type to obtain an anomaly score for a line graph detection.

6. The anomaly cause detection method according to claim 5, wherein the searching for an anomaly log in the logs based on the anomaly time instant and the detection type corresponding to the comprehensive anomaly score time-series curve comprises at least one of:
in response to the anomaly detection type being the log sequence detection, searching for an anomaly log sequence corresponding to the anomaly time instant, and determining, among the logs, a log that forms the anomaly log sequence as the anomaly log; or
in response to the anomaly detection type being the log structure detection, searching for an anomaly log parsing tree corresponding to the anomaly time instant, and searching for the anomaly log based on the anomaly log parsing tree; or
in response to the anomaly detection type being the log category detection, determining an anomaly log category based on an occurrence frequency of the preset log category at the anomaly time instant, and determining, among the logs, a log generated at the anomaly time instant and corresponding to the anomaly log category as the anomaly log; or
in response to the anomaly detection type being the discrete variable detection, determining an anomaly preset value based on an occurrence frequency of the preset value of the discrete variable at the anomaly time instant, and determining, among the logs, a log generated at the anomaly time instant and comprising the anomaly preset value as the anomaly log; or
in response to the anomaly detection type being the numerical clustering detection, determining an anomaly numerical value outside the numerical cluster at the anomaly time instant, and determining, among the logs, a log generated at the anomaly time instant and comprising the anomaly numerical value as the anomaly log; or
in response to the anomaly detection type being the line graph detection, searching for an anomaly line graph corresponding to the anomaly time instant, determining an anomaly numerical value in the anomaly line graph which falls outside the outlier determination numerical interval, and determining, among the logs, a log generated at the anomaly time instant and comprising the anomaly numerical value as the anomaly log.

7. The anomaly cause detection method according to claim 1, wherein after the searching for an anomaly log in the logs based on the anomaly time instant and the detection type corresponding to the comprehensive anomaly score time-series curve, the anomaly cause detection method further comprises:
generating a fault detection text based on the anomaly log;
inputting the fault detection text into a pre-trained language model to obtain a priority ranking of the anomaly log by the pre-trained language model, wherein the pre-trained language model is trained with a preset priority order for the anomaly log; and
outputting the priority ranking.

8. The anomaly cause detection method according to claim 2, wherein after the searching for an anomaly log in the logs based on the anomaly time instant and the detection type corresponding to the comprehensive anomaly score time-series curve, the anomaly cause detection method further comprises:
generating a fault detection text based on the anomaly log;
inputting the fault detection text into a pre-trained language model to obtain a priority ranking of the anomaly log by the pre-trained language model, wherein the pre-trained language model is trained with a preset priority order for the anomaly log; and
outputting the priority ranking.

9. The anomaly cause detection method according to claim 3, wherein after the searching for an anomaly log in the logs based on the anomaly time instant and the detection type corresponding to the comprehensive anomaly score time-series curve, the anomaly cause detection method further comprises:
generating a fault detection text based on the anomaly log;
inputting the fault detection text into a pre-trained language model to obtain a priority ranking of the anomaly log by the pre-trained language model, wherein the pre-trained language model is trained with a preset priority order for the anomaly log; and
outputting the priority ranking.

10. The anomaly cause detection method according to claim 4, wherein after the searching for an anomaly log in the logs based on the anomaly time instant and the detection type corresponding to the comprehensive anomaly score time-series curve, the anomaly cause detection method further comprises:
generating a fault detection text based on the anomaly log;
inputting the fault detection text into a pre-trained language model to obtain a priority ranking of the anomaly log by the pre-trained language model, wherein the pre-trained language model is trained with a preset priority order for the anomaly log; and
outputting the priority ranking.

11. The anomaly cause detection method according to claim 5, wherein after the searching for an anomaly log in the logs based on the anomaly time instant and the detection type corresponding to the comprehensive anomaly score time-series curve, the anomaly cause detection method further comprises:
generating a fault detection text based on the anomaly log;
inputting the fault detection text into a pre-trained language model to obtain a priority ranking of the anomaly log by the pre-trained language model, wherein the pre-trained language model is trained with a preset priority order for the anomaly log; and
outputting the priority ranking.

12. The anomaly cause detection method according to claim 6, wherein after the searching for an anomaly log in the logs based on the anomaly time instant and the detection type corresponding to the comprehensive anomaly score time-series curve, the anomaly cause detection method further comprises:
generating a fault detection text based on the anomaly log;
inputting the fault detection text into a pre-trained language model to obtain a priority ranking of the anomaly log by the pre-trained language model, wherein the pre-trained language model is trained with a preset priority order for the anomaly log; and
outputting the priority ranking.

13. An anomaly cause detection apparatus, comprising:
an anomaly detection module, configured to perform a plurality of types of anomaly detection operations on logs generated by a target system to obtain anomaly scores for respective detection types, and generate anomaly score time-series curves corresponding to the respective detection types;
a curve correlation module, configured to perform correlation analysis on the anomaly score time-series curves, fuse correlated anomaly score time-series curves among the anomaly score time-series curves into a comprehensive anomaly score time-series curve, and determine a detection type corresponding to the comprehensive anomaly score time-series curve;
an anomaly time instant detection module, configured to perform anomaly detection on the comprehensive anomaly score time-series curve, and determine an anomaly time instant at which an anomaly occurs in the comprehensive anomaly score time-series curve; and
a log searching module, configured to search for an anomaly log in the logs based on the anomaly time instant and the detection type corresponding to the comprehensive anomaly score time-series curve, to determine an anomaly cause of the target system based on the anomaly log.

14. An electronic device, comprising:
a memory, configured to store a computer program; and
a processor, configured to implement the anomaly cause detection method according to claim 1 when executing the computer program.

15. A non-transitory computer-readable storage medium, wherein a computer-executable instruction is stored in the non-transitory computer-readable storage medium, and the computer-executable instruction, when being loaded and executed by a processor, causes the processor to implement the anomaly cause detection method according to claim 1.
